(19) United States
(12) Patent Application Publication
(10) Pub. No.: US 2008/0099283 A1
(43) Pub. Date: May 1, 2008

(54) Lift Apparatus and Method for Forming Same

(76) Inventor: Robert Jacobus Reigwein, Waddinxveen (NL)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/739,466

(22) Filed: Apr. 24, 2007

(30) Foreign Application Priority Data
Oct. 25, 2006 (EP) 06076933.8

(51) Int. Cl. B66B 9/00

(52) U.S. Cl. 187/239

(57) ABSTRACT

A lift apparatus, comprising a series of modules arranged one on top of the other, wherein each module comprises a part of a lift shaft and is provided with at least one lift safety door for clearing and closing off the respective part of the lift shaft, while the parts of the lift shaft extending in the respective modules form part of a continuous lift shaft, wherein drive means for a lift car are provided, while the different modules are provided with lift guiding means for guiding the lift car through the lift shaft.

### CROSS REFERENCE TO RELATES APPLICATION (S)

This application is a continuation of European Patent Application No. 06076933.8, filed Oct. 25, 2006, the contents of which is hereby incorporated by reference in it's entirety.

The invention relates to a structure. The invention relates in particular to a structure comprising a lift.

When constructing new buildings, or reconstructing, maintaining or renovating buildings, access to storeys, and dwellings, businesses and other living areas located thereon becomes difficult if not impossible via existing staircases, lifts and the like. This may be because they have been closed off for maintenance or alteration, or are not yet or not yet fully operational. In such cases, it is known to erect an open builder's hoist next to the respective building, with which persons and goods can be moved along the outside of the building. As a rule, such builder's hoists have a standard height and a wholly or partly open construction, in particular with respect to the lift car. Next to it, ladders or such temporary climbing devices are placed. These too have as a drawback that they are of wholly or partly open construction and have to be assembled in situ.

The object of the invention is to provide a structure of the type described in the introduction, with which at least one of the drawbacks mentioned or other drawbacks is/are prevented.

The object of the invention is, in particular, to provide as structure a lift apparatus which offers a good protection to users, can be placed and used in a simple manner, in particular as a temporary lift apparatus, and, moreover, with different buildings, having, in particular, different floor heights.

At least one of these or other objects is achieved according to the invention with a structure, in particular a lift apparatus, according to claim 1.

With a lift apparatus according to the invention, use is made of a series of modules which are stacked onto each other. Each module comprises a part of a lift shaft. Furthermore, in each module, at least one lift safety door is provided for clearing or closing off the part of the lift shaft. In stacked condition, the parts mentioned in the respective modules form part of a continuous lift shaft. In the lift shaft are provided a lift car and lift guiding means, with which the lift can be guided through the lift shaft, along the respective lift safety doors. Preferably, an end module is provided at the top end of the lift apparatus, which closes off at least the uppermost module, at least, the or each lift shaft. Drive means such as a motor and/or gear wheels are provided for moving the lift car through the lift shaft. Such drive means can be provided wholly or partly in and/or on, for instance, the lift car.

It is preferred here that the lift car is a standard lift car having its own door or doors, which, in normal conditions of use, are opened or can be opened only if the lift car is located at the level of a lift safety door. This opening occurs preferably only automatically for, for instance, enhancing the safety.

With a lift apparatus according to the invention, the advantage is achieved that in a particularly simple and safe manner, a temporary lift apparatus can be built up, for instance in or against a building or a part thereof, while obtaining a large degree of flexibility. The fact is that the number of modules utilized can simply be geared to the height and/or the number of storeys of at least a part of the building. It is further preferred here that each module has a height that corresponds to a standard storey height of the respective building, more particularly to a standard storey height of a storey height laid down by the respective authorities.

It is preferred that the lift apparatus as such is a standard lift apparatus as supplied by, for instance, Thyssen, Otis, Mitsubishi or such suppliers. However, the lift apparatus can naturally also have been or be manufactured especially for a lift apparatus according to the invention. Preferably, the lift apparatus used is a lift apparatus that meets the Directive Relating to lifts 95/16/EG, or Lifts Directive.

Next to the or each lift safety door in the modules, preferably, a 30 storey floor is provided, whereby the safety is even further enhanced.

One or more intermediate modules can be provided, in order to, for instance, adjust the height of a module to a deviating storey height of a building with which the lift apparatus is used. With this, the flexibility is even further enhanced. It is preferred here that the intermediate module has a height that deviates from the height of the modules. Preferably, the modules are equal to each other or a series of sizes of modules is provided which may, for instance, be mutually stackable but which have different heights. Furthermore, also the intermediate modules are equal to each other, while, optionally, a series of types of intermediate modules can be provided, with the types mutually differing in height.

In a particularly advantageous embodiment, each module and, optionally, intermediate module is provided, in addition to a part of a lift shaft located therein, with a part of a stairs such that modules and, optionally, intermediate modules stacked onto each other form continuous stairs interconnecting different storeys in a building and/or in the modules. The or each part of the stairs can be provided in a module but is preferably arranged in a separate stair module, which stair modules, like the modules, are stackable and match the module preferably as regards sizes, substantially as regards height. It is preferred that the height of the modules is equal to that of the stair modules. Also, stair intermediate modules can be provided, comparable to the intermediate modules.

If modules and stair modules are used, with or without (stair) intermediate modules, the modules and the stair modules are preferably interconnected by a passage at the or each storey. This further simplifies the use of the different modules.

The modules, stair modules, intermediate modules and/or stair intermediate modules preferably comprise a frame for making them stackable. The outside, at least viewed in circumference, of the or each (stair) intermediate module is preferably formed by a substantially watertight and wind tight closure. Especially the intermediate modules can be formed with it as a sort of wind-tight and watertight intermediate ring. It is preferred that with such an intermediate ring, a difference in height of approximately 20 cm can be compensated. Preferably, an operating device is provided with which the lift car, at least the lift apparatus, is operable and/or callable at least from the lift car and also, at each lift safety door. It is preferred here that the or each lift car and/or lift safety door cannot not be opened other than with special tools if the lift car is not located next to the respective lift safety door. In this manner, a user is prevented from inadvertently stepping into the lift shaft.

During use, it is preferred that a base is provided under the lowest module, in which buffer means are included for at least partly catching the lift car. It is preferred that this base is provided in or designed as a foundation, in particular a temporary foundation of, for instance, steel and/or concrete.

In a preferred embodiment, it is preferred that the lift apparatus comprises modular rail parts which are attached to the modules. These rail parts can advantageously be built up and attached against the modules in the lift shaft. The rail parts guide the lift car along the lift shaft.

In another preferred embodiment, the lift apparatus comprises mast sections which support the rail parts. Thus, in a highly favourable manner, a support of the rail part is provided which can be of relatively simple modular design. Mast sections are for instance also known from crane construction. The combination of rail parts and mast sections can be modularly constructed. Also, the desired constructive strength is achieved, on which very high requirements are imposed.

With favourable embodiments of the invention, the rail parts can be slid relative to the modules. The rail parts can then both be shorter and longer than the height of a module. A number of modules are, for instance, stacked and mast sections are attached thereto, whereupon the rail parts are slid into the apparatus relative to the mast sections. The mast sections and the rail parts can also be attached to each other in advance, and then be connected to the modules, or lift shaft, preferably through the above-mentioned sliding.

Further, in a most favourable embodiment, the lift cur is driven with the aid of the toothed rack driving technique. Here, at least one gear wheel is provided which is driven by the drive means. With the aid of this gear wheel, the lift car is conducted along the at least one rail part, which comprises at least one toothed rack.

The invention further relates to a module and to a stair module for use in a lift apparatus according to the invention.

The invention further relates to a structure according to claim 25.

The invention further relates to a method for providing a lift apparatus according to any one of claims 1-20.

The invention further relates to a method for providing a lift apparatus for a building, wherein next to and/or in a building a lift apparatus according to any one of claims 1-20 is built up. With such a method, a particularly robust and safe lift apparatus and/or stairs can be provided in a relatively rapid and simple manner, in particular for temporary use, while obtaining a large degree of flexibility.

In one embodiment, a lift apparatus according to any one of claims 1-20 is further provided with a frequency regulator. With it, shocks are prevented.

In clarification of the invention, exemplary embodiments of a lift apparatus and method according to the invention will be further elucidated on the basis of the drawing. In the drawing:

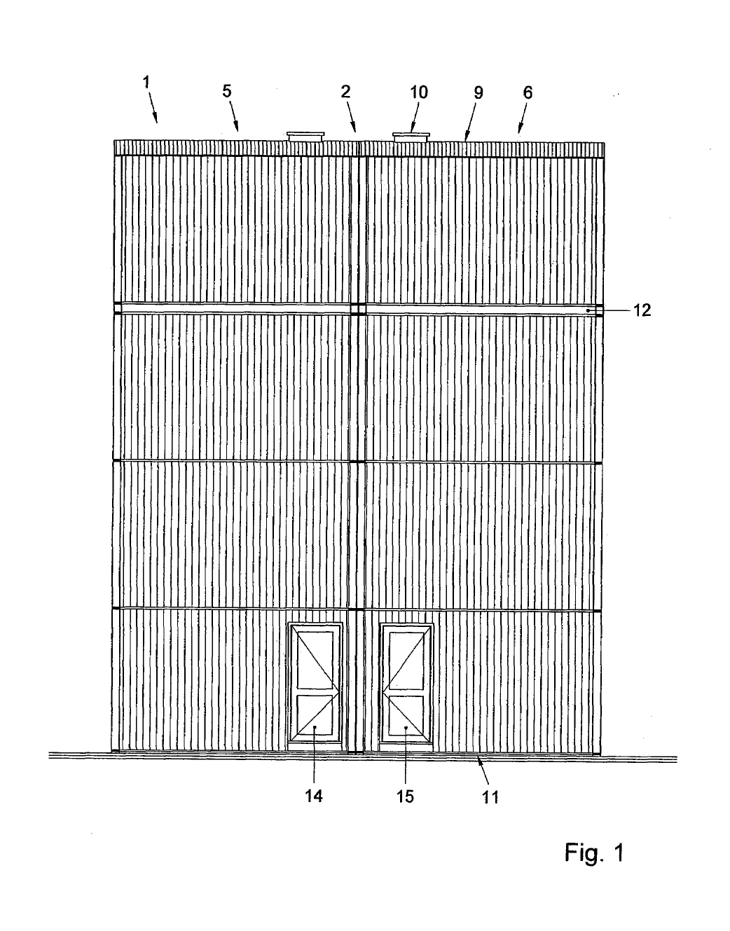

FIG. 1 shows, in front view, a lift apparatus according to the invention, composed of two towers of containers;

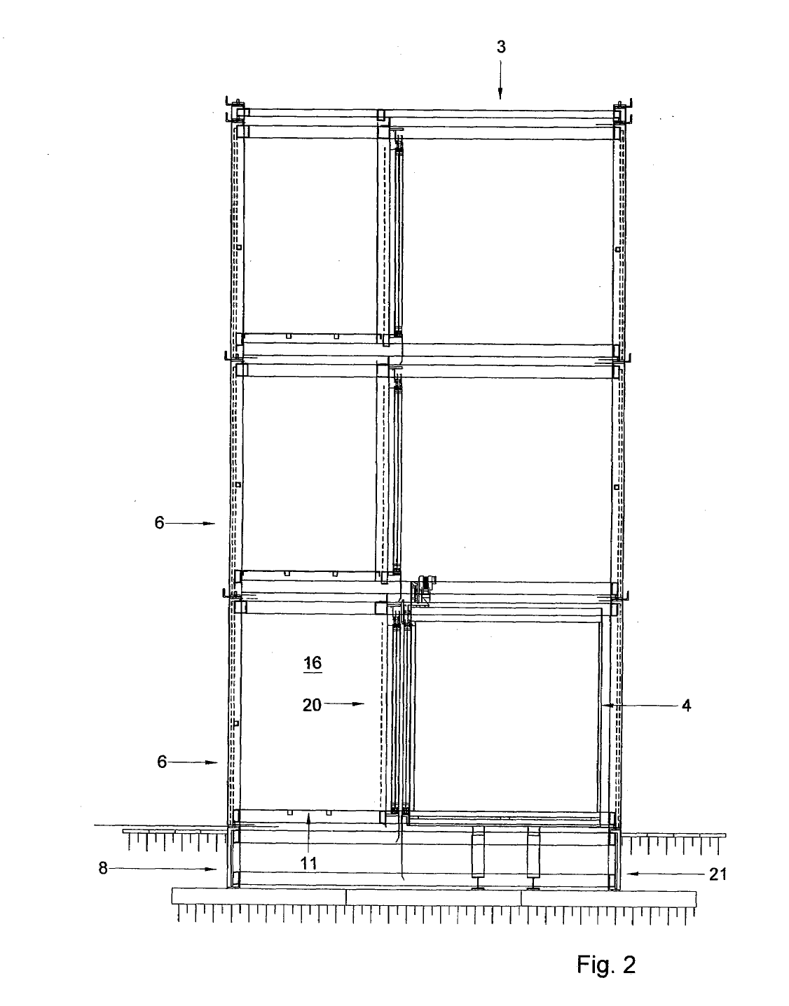

FIG. 2 shows, in front view, a cross section of a part of the apparatus according to the invention;

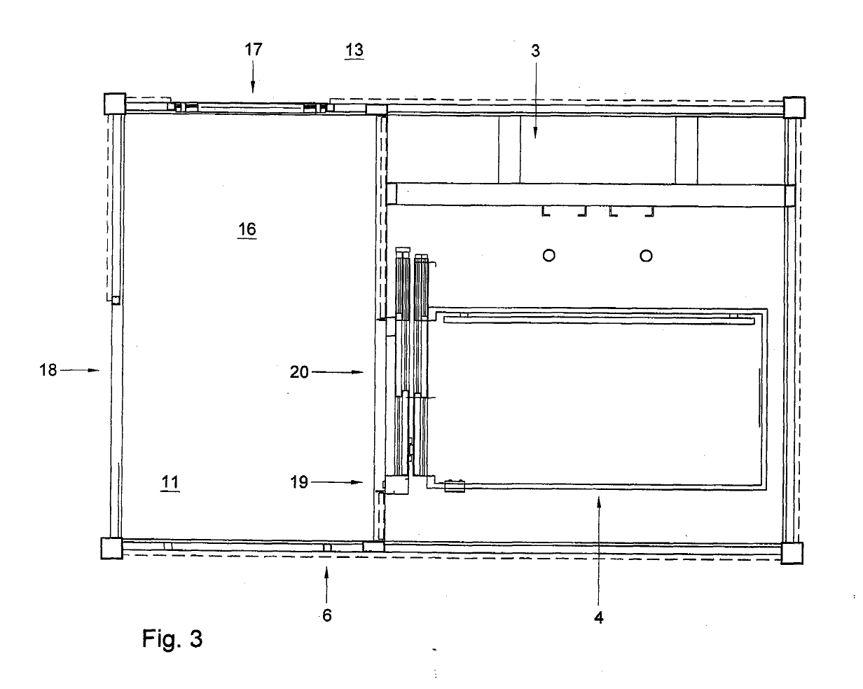

FIG. 3 shows, in top plan view, a cross section of a part of the 30 apparatus according to the invention;

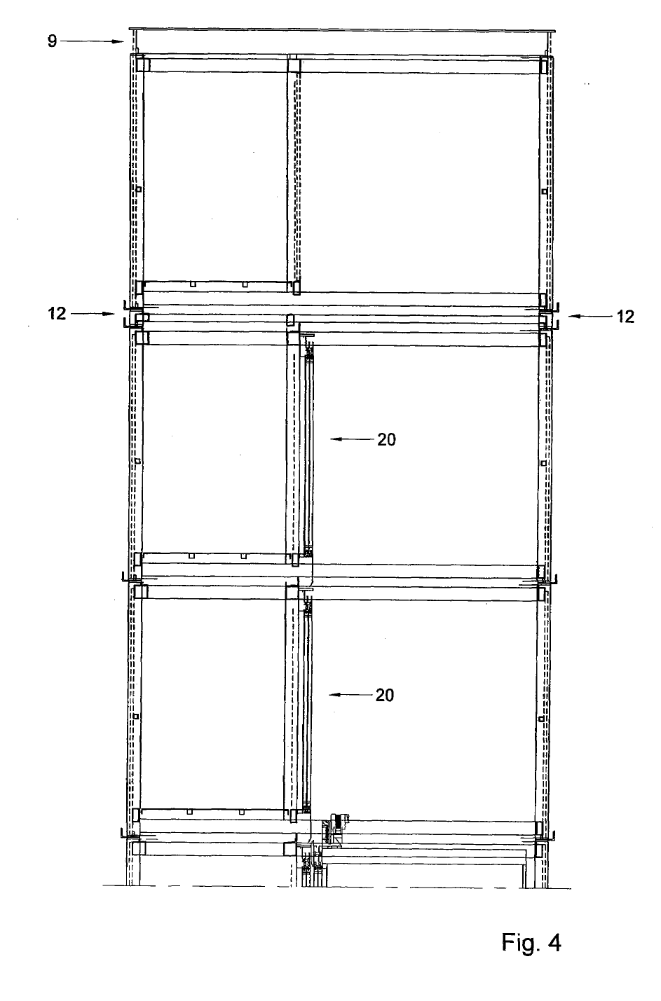

FIG. 4 shows, in front view, a cross section of a part of the apparatus according to the invention provided with an intermediate part and a roof;

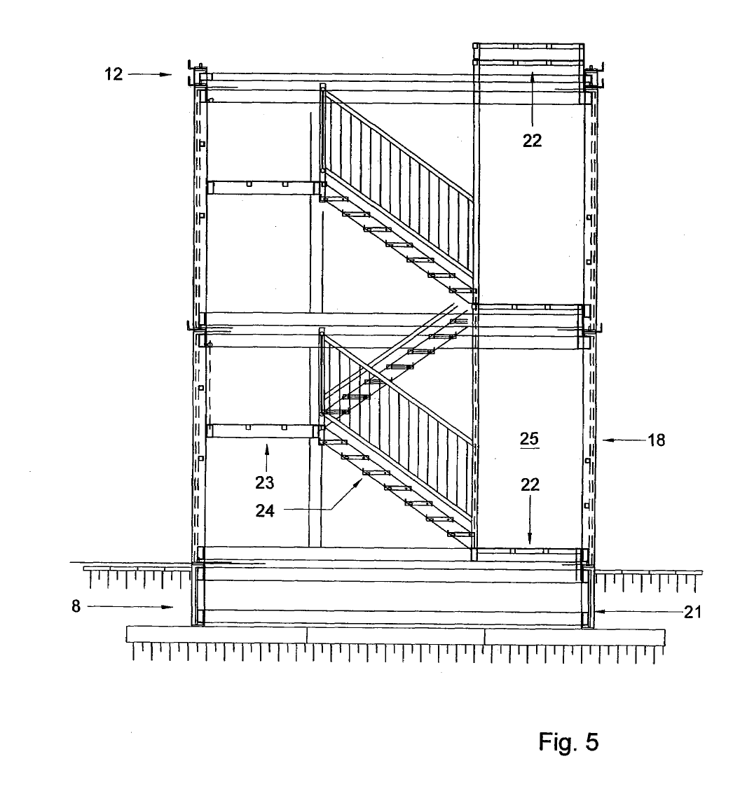

FIG. 5 shows, in front view, a cross section of a part of the apparatus according to the invention;

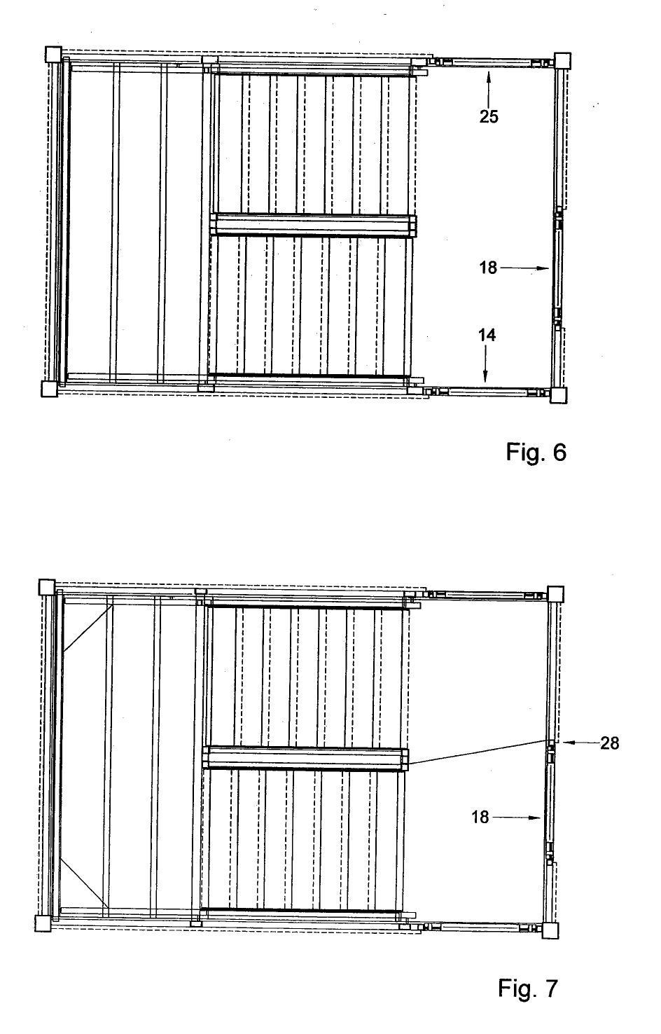

FIG. 6 shows, in top plan view, a cross section of a part of the apparatus according to the invention;

FIG. 7 shows, in top plan view, a cross section of a part of the apparatus according to the invention in a different embodiment than FIG. 6;

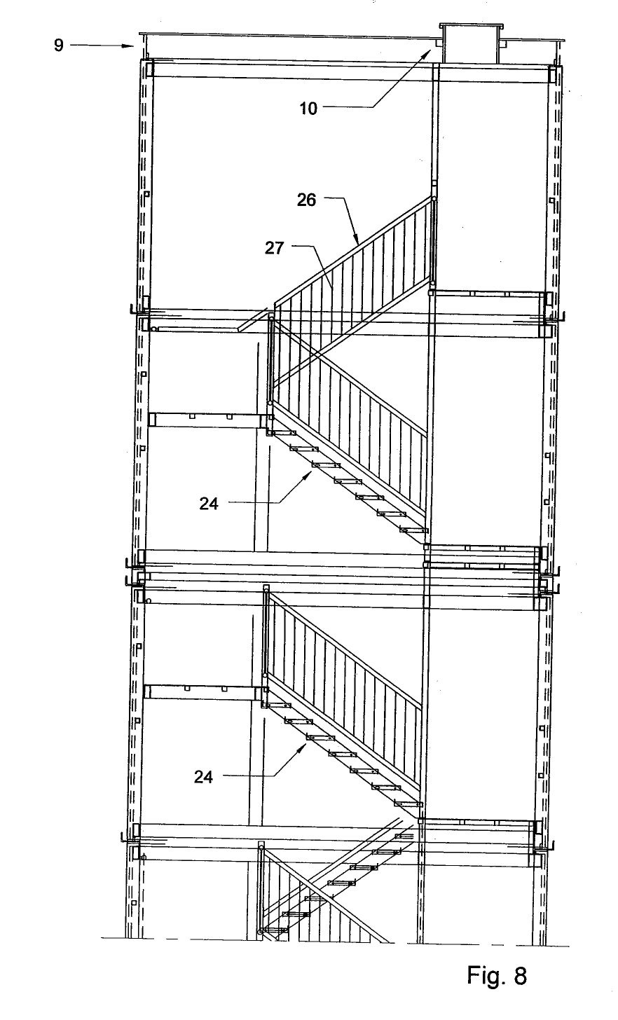

FIG. 8 shows, in front view, a cross section of a part of the stairs tower according to the invention provided with an intermediate part and a roof;

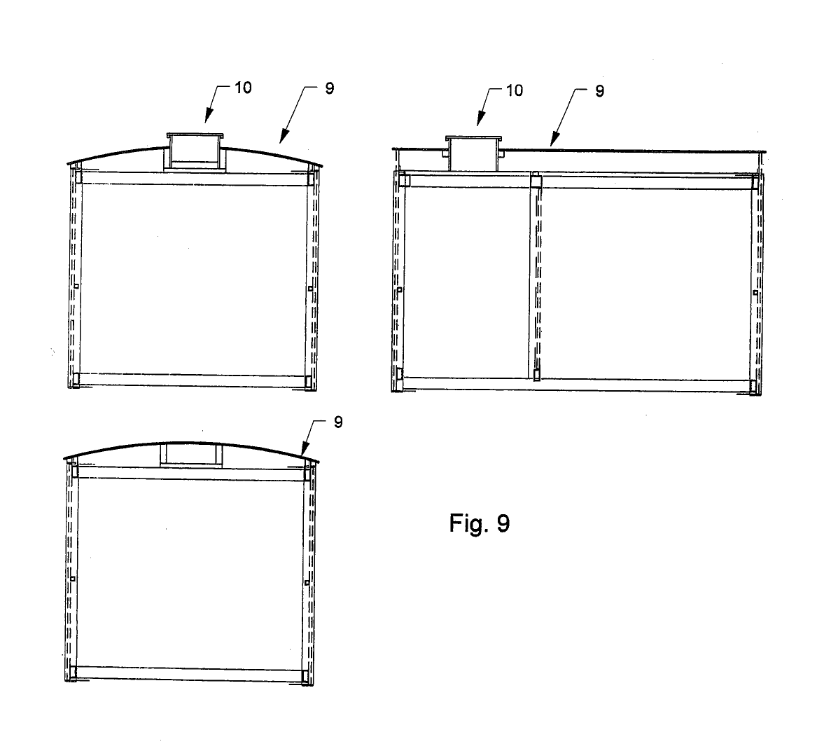

FIG. 9 shows, in side and front views, cross sections of different roof parts of a tower according to the invention;

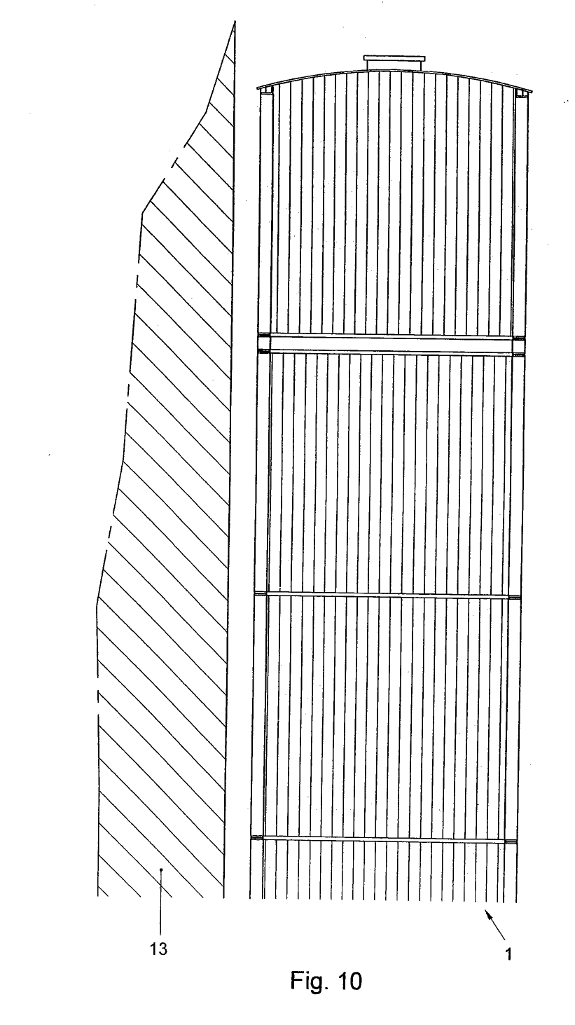

FIG. 10 shows, in side view, a cross section of a tower according to the invention;

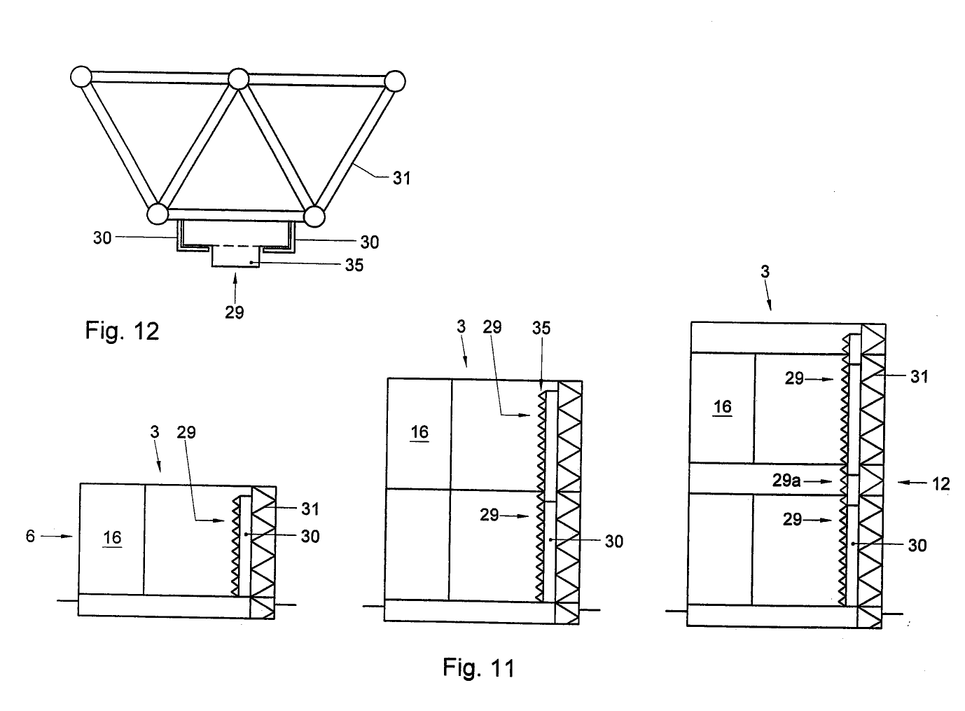

FIG. 11 shows, in side view, schematically, different cross sections of lift towers according to the invention;

FIG. 12 shows, schematically in top plan view, a mast section with a rail part and guide means;

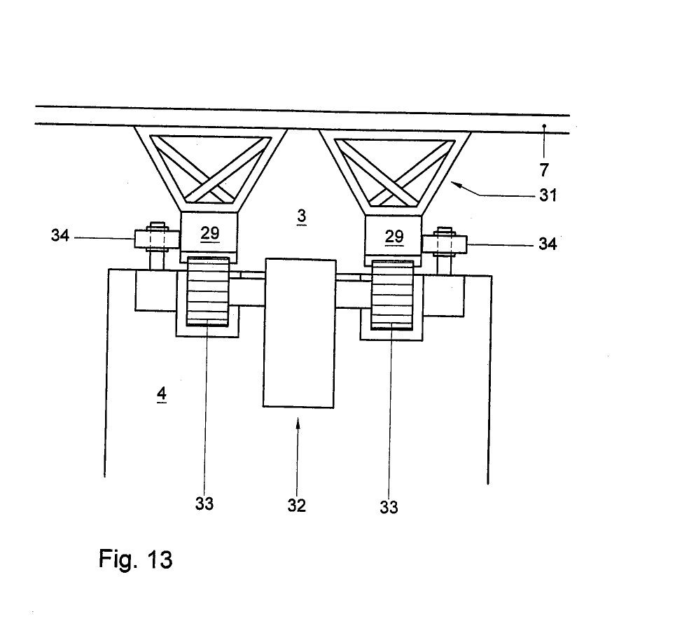

FIG. 13 shows, schematically in top plan view, a driving principle with guiding according to the invention; and

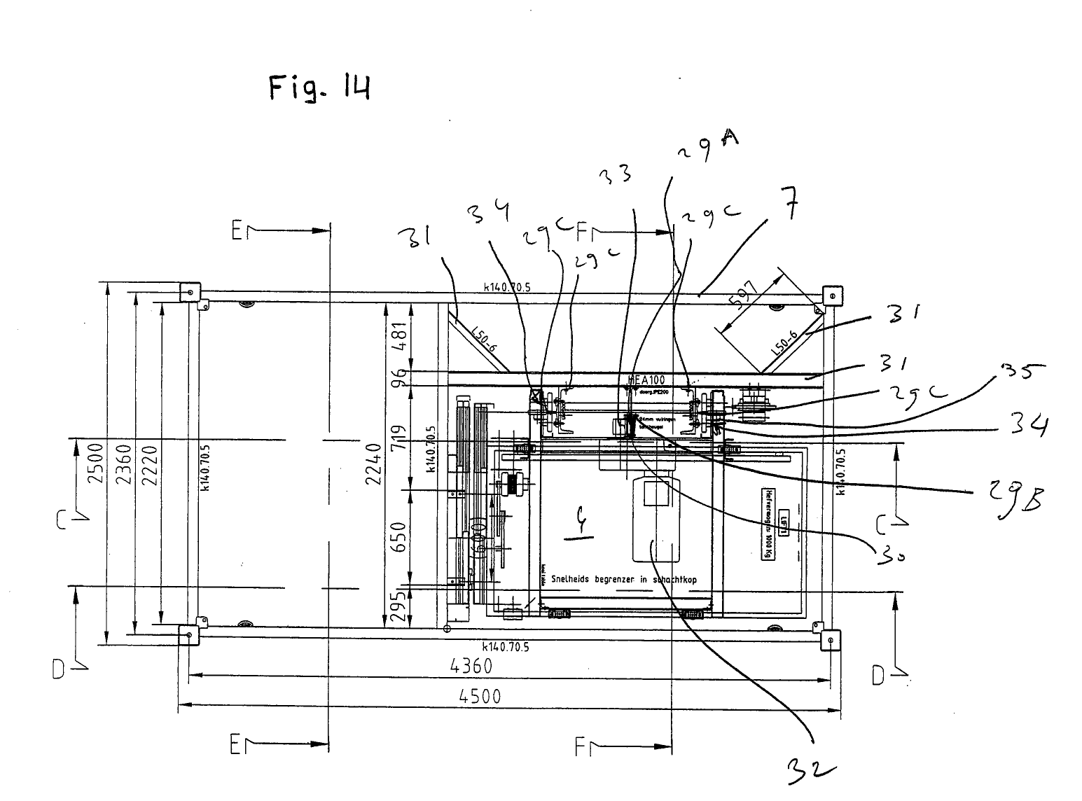

FIG. 14 schematically shows, in top plan view, a part of a lift apparatus according to the invention.

In this description, identical or corresponding parts have identical or corresponding reference numerals.

In the drawing, embodiments are merely shown by way of example. The parts of the lift apparatus used there are only mentioned by way of example and are not to be understood to be limitative in any manner. Other parts of the lift apparatus too can be utilized within the framework of the present invention.

In this description, embodiments of a lift apparatus according to the invention will be shown, while both a lift shaft and a stairs tower are shown. The lift shaft and the stairs tower are both of modular construction, from modules and intermediate modules, and stair modules and stair intermediate modules, respectively. Preferably, all these modules comprise substantially robust steel constructions. In the description, these will also be indicated as “containers”.

FIG. 1 shows, in front view, a temporary lift apparatus 1 according to the invention, placed at a building 13, shown in FIG. 10. In the present embodiment shown in FIG. 1, the lift apparatus is designed having towers 2 comprising a stairs tower 5 and a lift tower 6. Each of the towers 2 comprises a column of stacked modules in the form of containers 7 virtually open at the bottom and top side, while each time, per storey of the building, one container 7 is provided. In principle, these containers 7 comprise four walls. It goes without saying that a comparable part that does not necessarily fall within the category of “container” still falls within the framework of the term “container” chosen here. Hereafter, according to the function of the respective container 7, elements are suspended therein/thereon. This function may depend on whether or not the container 7 is provided in the stairs tower or lift tower 5, 6. In case the height of a storey does not satisfactorily match the height of a container 7, an intermediate module or intermediate part 12 can be placed, as is also represented in FIG. 1. Doors 14, 15 provide access to the towers 2 from the ground floor.

In a preferred embodiment, these doors 14, 15 are provided at the front of the apparatus 1, it is, naturally, also possible to provide these at the side or any side of a tower 2. Naturally, in the towers 2, per storey, entrances are arranged to the storeys of the building 13, so that one can step from the stairs tower 5 or lift tower 6 to a storey of the building 13.

In FIG. 2, in front view, a lift tower 6 is shown, provided with a lift shaft 3 and a lift car 4. In each container, waiting spaces 16 are provided with a floor part 11 which approximately links up with a floor of a storey of the building 13, this floor part can for instance be an anti-skid floor. Here, the waiting space 16 can provide space for approximately ten persons who can wait for a lift car 4 in the lift tower 6. Under the lift tower 6, a free space 8 is dug wherein a base part 21 can be placed, on which the lowest containers 7 of the lift towers 6 and/or stairs tower 5 are placed.

As can be seen in FIG. 3, it is possible to walk from the waiting space 16 through the door 17 to a storey of the building 13. One can walk through the communicating door 18 into the interior of the stairs tower 5. The communicating door 18 may be provided in stairs tower 5 and/or lift tower 6. It can be seen in FIG. 3 that an operating panel 19 with lift buttons is arranged adjacent lift doors 20, which are provided at the entrance to the lift car 4. It will be clear that within the lift shaft 3, also, transmission means and guiding means are present for the purpose of automated transport of lift car 4. In this description, embodiments of the lift apparatus will be discussed, with which, for instance, the guiding means comprise rail parts, in particular a toothed rack system, and the transmission means are, for instance, drive means provided on the lift.

As can be seen in front view in FIG. 4, with the aid of the intermediate module 12, a variation in storey height in the lift apparatus 1 is ensured, so that the lift car 4 can link up with storeys of a building 13 not having a standard height, in particular other than for instance 2715 mm, more particularly 2900 mm. In this manner it is easy to step over a substantially horizontal surface from the waiting space 16 through door 17 to a storey of the building 13. In FIG. 4 it can be seen how this part 12 has been modularly set up between the containers 7. It is also shown how the lift tower 6 is covered at the top by a roof 9.

FIG. 5 shows a cross section in front view of a part of the stairs tower 5. As is the case with the lift tower 6, here, a free space 8 has been dug for placing a base frame 21. Within the stairs tower 5, a stairs configuration is placed which comprises stairs 24, platforms 23 and banisters 26 with spindled gates 27. Between two stairs 24, a platform 23 is provided and per storey, a landing 22 is placed. Via this landing 22, one can walk through the door 18 to the waiting space 16, via this landing 22 too, one can cross through door 25 to a storey of the building 13. Like the lift tower, the stairs tower can be built up from module types, in the present case indicated as stair modules and/or stair intermediate modules. In each stair module and/or stair intermediate module, a part of the stairs is included.

In FIGS. 6 and 7, embodiments of cross sections of a top plan view of the stairs tower 5 are represented. One can directly cross through door 25 to a storey of the building 13. FIG. 7 shows an elevation 28. If the container 7 of the stairs tower is not at the level of the ground floor, the door 14 is most probably omitted.

FIG. 8 shows the top part of the stairs tower 5 in a cross section of the front view. Banisters 26 and spindled gates 27 are provided at the stairs 24. A hatch 10 is arranged in the roof 9. Variants to this roof 21 with or without hatch 10 are shown in FIG. 9. FIG. 10 shows a side view of the lift apparatus 1, while a crossing possibility between the tower 2 and the building 3 is not shown. The tower 2 can also be placed closer to the building 3.

In each module 7, on each storey, a safety lift door is provided which closes off the lift shaft from the storey and cannot be opened without tools or a key if the lift car is not situated with a lift car door provided therein adjacent the respective safety lift door. Preferably, the lift safety door is opened automatically. Consequently, the safety is enhanced.

In each module 7 and/or intermediate module 12, in the lift shaft 3, a part of at least one rail 29 is provided which is included in guiding means 30 so that this rail part 29 is slideable in vertical direction of the respective module 7 and/or intermediate module 12. This is schematically represented in FIGS. 11-13. In this manner, with stacked modules 7 and/or intermediate modules 12, rail parts 29 of the different (intermediate) modules 7, 12 can be slid onto each other, optionally with interposition of intermediate rail parts 29a, so that at least one continuous rail 29, 29a is formed in the lift shaft 3. The rail parts 29, 29a are provided with a toothing 35 for engagement of a drive 32 with at least one fitting gear wheel 33 arranged on the lift car. As a result, the lift car 4 can be moved accurately and simply upward and downward along the or each rail 29 through the lift shaft 3, while the length of the or each rail 29 can simply be adjusted to the height of the lift shaft 3 and/or the height of the different storeys.

In order to support the rail part 29, in a highly advantageous manner, mast sections 31 can be used. Such a mast section principle is already known from, for instance, crane construction. The mast sections 31 can also be especially designed for the present lift apparatus use. Advantageously, these mast sections 31 can be modularly built up/stacked and be connected to the (intermediate) modules 7, 12. The rail parts 29 can be connected to the mast sections 31 with the aid of, for instance, guiding means 30. In one embodiment, the mast sections 31, guiding means 30 and/or rail parts 29 are already connected to the containers 7 prior to build-up of the apparatus 1. Therefore, the containers 7 are provided with mast sections 31, guiding means 30 and/or rail parts 29 which are, for instance, fixedly connected to the container 7. In this configuration, the containers can be used several times in a lift apparatus 1. This means that except for the first use of the respective lift apparatus 1, before build up of a lift apparatus 1, the mast sections 31, guiding means 30 and/or rail part 29 need, in principle, not be mounted and after removal of the lift apparatus 1, these mast sections 31, guiding means and/or rail parts 29 need not be dismantled. When stacking the containers 7, successive mast sections 31, guiding means 30 and/or rail parts 29 will virtually link up with each other so that the lift apparatus 1 can be built up efficiently. In this embodiment, stacking of the containers 1 with said parts 29, 30, 31 can be accomplished in fewer assembly steps.

In an advantageous embodiment, the lift apparatus 1 comprises a toothed rack system. With it, essentially, an entire lift driving and guiding principle can be constructed, in a robust and modular manner. Here, the pail parts 29 preferably comprise toothed racks 29. In a favourable manner, the lift car 4 can be connected to drive means 32, which drive gear wheels 33 with which the lift car 4 is conducted upwards and/or downwards along the toothed rack 29. For additional guidance and to prevent the lift car 4 from veering, additional guiding means 34 can be provided which can keep the lift 4 and the gear wheels 33 in the desired position.

Naturally, the rail parts 29 and/or mast sections 31 can be chosen to have any desired length, with which they are favourably stacked and, preferably, slid relative to the (intermediate) modules 7, 12. The entire guiding system of rail parts 29 and/or mast sections 31 and/or guiding means 30, 34 can also be built up separately from the lift apparatus. Also, the guiding system can be built up separately for, for instance, a number of floors, for instance two or three, and then be slid relative to the modules 7, 12 into the lift shaft 3. In an advantageous manner, two guiding systems can be provided, with which the lift car 4 is driven and guided at two points with the aid of, for instance, two (optionally stacked) mast sections 31 and two (optionally stacked) toothed rack rails 29, while a drive means 32 with at least two gear wheels 33 is provided on the lift car. One possible embodiment hereof is schematically represented in FIG. 13.

As can be seen in FIG. 14, in certain embodiments, rail parts 29 can comprise certain sections, which are already freely available on the market. In one embodiment, the toothed rack 29A is attached to a T-section 29B, while the toothed rack 29A may have been slid into a toothed rack guide 30, in the shape of, for instance, a U-section. Also, rail parts 29C are provided, at the outsides of the toothed rack 29A and parallel thereto, along which can be guided lift guiding means 34, for instance bogies with wheels 34, for keeping the lift car 4 in position. These rail parts 29C can, for instance, comprise extrusion sections, for instance sections already freely available on the market. At the lift guiding means 34, slide brakes 35 may be provided forming part of a speed limiting system for the lift car 4. The speed limiting system is furthermore provided with a speedometer which measures the speed of the lift car 4. This speedometer is for instance placed according to a known principle, at an upper part of the lift shaft 3 and measures the speed of the lift by measuring, for instance, the speed of a lift cable. This speedometer sends a signal to the drive means 32 when too high a speed of the lift car 4 is measured. This signal switches the drive means 32 off. Also, the signal activates the slide brakes 35 which reduce the speed of the lift car 4 by means of friction on the rail parts 29C and/or the guiding means 34, optionally until standstill.

The modules 7, intermediate modules 12, and also stair modules and stair intermediate modules that may be provided in the stairs tower can all be designed with standard dimensions, while each desired construction height and intermediate distance between storeys can be bridged. A lift apparatus 1, together or not together with a stairs tower 5, can be built up simply and rapidly and offers a good protection to users, and can be safely and simply removed. The lift apparatus 1 can be designed to be largely self-supporting, so that anchoring to, for instance, a building next to which it has been erected can be limited to a minimum.

The invention is not limited in any manner to the exemplary embodiment represented in the description and the drawing. Many variations thereon a possible within the framework of the invention as set forth by the claims. For instance, lift tower and stairs towers 5, 6 need not be placed directly against or next to each other but can also be deployed at a distance from each other. It is, for instance, also possible to place a lift shaft 3 instead of a lift tower 6. It is also conceivable that the lift shaft 3 is placed in, for instance, the stairs tower 5.

It is also preferred that a frequency regulator or other interference prevention and/or shock prevention electronic means is provided with a lift apparatus according to the invention. With it, also, in an advantageous manner, the speed of the lift car 4 can be dosed.

Preferably, the invention is designed such that the fire department and maintenance services can simply find a passage with the aid of the invention, this is also possible as the invention takes into account the standard heights and requirements at structures.

The invention is also suitable for permanent placing. The stairs tower 5/stair modules can be provided in a favourable manner with a wall covering, for instance for insulation. The tower 5 can also be provided with a fixed stairs and a flexibly adjustable platform 23 which meet the specific standards. Half of the platform can be height-adjustable so that an additional tread or rise is formed. Also, intermediate rings can be utilised in the stairs tower/stair modules. In an advantageous manner, emergency lighting can be provided in the stairs tower.

These and many comparable variations are understood to fall within the framework of the invention as set forth by the claims.

What is claimed is:

1. A lift apparatus, comprising a series of modules arranged one above the other, wherein each module comprises a part of a lift shaft and is provided with at least one lift safety door for clearing and closing off the respective part of the lift shaft, the parts of the lift shaft extending in the respective modules forming part of a continuous lift shaft, while drive means for a lift car are provided, and wherein the different modules are provided with lift guiding means for guiding the lift car through the lift shaft.

2. A lift apparatus according to claim 1, wherein each module is provided with a storey floor next to the respective lift safety door.

3. A lift apparatus according to claim 1 or 2, wherein the lift car is provided with at least one preferably automatic lift car door.

4. A lift apparatus according to any one of the preceding claims, wherein at least one intermediate module is provided between at least two modules arranged one above the other.

5. A lift apparatus according to claim 4, wherein the modules have a first height and the or each intermediate module has a second height, while the first and second height are unequal.

6. A lift apparatus according to any one of the preceding claims, wherein the modules are provided with a substantially wind-tight and rain tight outer wall and a substantially open bottom side and/or top side.

7. A lift apparatus according to any one of the preceding claims, wherein in or next to each module, a stair module is provided with stairs therein extending from near a bottom side of the respective stair module to near an opposite, top side of the respective stair module.

8. A lift apparatus according to claim 7, wherein each stair module is separated from the module, while the stair modules are stackable.

9. A lift apparatus according to claim 8, wherein the stair modules have a height that corresponds to the height of the modules.

10. A lift apparatus according to any one of claims 7-9, wherein at least one stair intermediate module is provided between two stair modules arranged one above the other.

11. A lift apparatus according to any one of claims 7-10, wherein each stair module comprises at least one storey floor, preferably adjacent a top side or bottom side thereof.

12. A lift apparatus according to claim 11, wherein modules and stair modules arranged next to each other are mutually connected and have storey floors located at approximately the same height.

13. A lift apparatus according to any one of the preceding claims, wherein the or each module, stair module, intermediate module, and/or stair intermediate module comprises at least one frame and/or intermediate ring with which said module, stair module, intermediate module and/or stair intermediate module is stackable.

14. A lift apparatus according to any one of the preceding claims, wherein an operating device is provided with which the lift car is callable from preferably each storey floor and the operating device has a safety switch such that each lift safety door can be opened, preferably automatically, only when the lift car is located at the level of the respective lift safety door, unless use is made of tools specially designed to this end.

15. A lift apparatus according to any one of the preceding claims, wherein under at least the lowest module a base is included which is provided with buffer means for catching the lift car.

16. A lift apparatus according to any one of the preceding claims, wherein a temporary foundation is provided under the lift apparatus.

17. A lift apparatus according to any one of the preceding claims, wherein each module and/or intermediate module is provided with at least one, and preferably at least two rail parts.

18. A lift apparatus according to claim 17, wherein each module and/or intermediate module is provided with at least one and preferably at least two, east sections, with which said rail part is connected to the module and/or intermediate module.

19. A lift apparatus according to claim 17 or 18, wherein said rail part and/or said mast section is slideable in vertical direction of the respective module, while preferably, the or each respective rail part and/or the or each respective mast section is slideable from one of the modules as far as at least partly into a module arranged on top thereof, for forming a continuous rail or rail with mast section running through the lift shaft.

20. A lift apparatus according to any one of claims 17-19, wherein the or each rail extends over at least a part, and preferably virtually the entire height of the lift shaft and is provided with a toothing, while drive means are provided on the lift car, provided with at least one gear wheel for driving the lift car along the or each said rail.

21. A lift apparatus according to any one of claims 17-20, wherein at least the rail parts and/or mast sections are fixedly connected to the module.

22. A lift apparatus according to any one of the preceding claims, provided with a speed limiter, preferably with slide brakes.

23. A module for use in a lift apparatus according to any one of the preceding claims.

24. A stair module for use in a lift apparatus according to any one of claims 7-22.

25. A structure, provided with a lift apparatus according to any one of claims 1-22.

26. A method for providing a lift apparatus according to any one of claims 1-22.

27. A method for providing a lift apparatus for a building, wherein next to the building a lift apparatus according to any one of claims 1-22 is erected.

28. A method according to claim 26 or 27, wherein the lift apparatus is built up from several modules, at least one of these modules comprising a container with mast sections and/or rain parts, while said mast sections and/or rail parts are already connected to the container prior to stacking of the modules and virtually link up with each other when stacking.

29. A lift apparatus according to any one of claims 1-22, wherein a frequency regulator is provided.
